(19) United States
(12) Patent Application Publication
(10) Pub. No.: US 2013/0319179 A1
(43) Pub. Date: Dec. 5, 2013

(54) CORK REMOVAL APPARATUS

(71) Applicant: Mark Colman, Abilene, TX (US)

(72) Inventor: Mark Colman, Abilene, TX (US)

(21) Appl. No.: 13/484,862

(22) Filed: May 31, 2012

(51) Int. Cl. B67B 7/04; B26B 11/00

(52) U.S. Cl. 81/3.09; 81/3.37; 81/3.45

(57) ABSTRACT

A cork removal device for facilitating the removal of a cork from a bottle, including a central body portion; a helix associated with the central body portion; a removal member attached to the central body portion; a ratchet assembly associated with the helix; and a stop indication member situated below the ratchet assembly and above a pointed end of the helix.

### TECHNICAL FIELD OF THE INVENTION

The invention relates, in general, to a device for removing a cork from a container and, in particular, to a corkscrew device having an improved insertion mechanism.

### BACKGROUND OF THE INVENTION

Without limiting the scope of the present invention, its background will be described with reference to corkscrews, as an example.

Various containers are sealed with a stopper such as a cork. The most common use of a cork as a stopper is in a wine bottle. Wine drinking has become a recreation of sorts for many and enjoying high quality wine is no longer a pleasure experienced only by the wealthy. High quality wines are produced by vineyards across the United States. These vineyards offer high quality wines to consumers at reasonable prices. Historically, an earmark of a wine of higher quality is the use of a cork to seal the wine bottle. In the past, less expensive wines may have been equipped with a metal screw cap to close the bottle. Today, however, wine that ranges in price from the very expensive to the very inexpensive are sealed with a stopper made of cork or a synthetic product having the appearance of a cork.

Regardless of the type of cork that is used to seal a bottle of wine, consumers have long been faced with the problem of extracting the cork from the bottle. There have been many devices, typically known as corkscrews, introduced to the marketplace for removing a cork from a wine bottle. These devices include a very simple t-shaped design corkscrew to more elaborate designs. A common corkscrew known in the art is the corkscrew key depicted in FIG. 1. In FIG. 1, corkscrew key 100 includes a round wire helix 102 having a pointed end 104 to facilitate insertion of the helix into a cork. Helix 102 is typically associated with a shaft member 106 that is pivotably attached to central portion of a lever arm 108. At one end of lever arm 108 a blade 110 pivotably attached at that serves as a foil cutter. At an opposite end of lever arm 108 a fulcrum 112 is pivotably attached to lever arm 108.

In typical operation, corkscrew key 100 is inserted into a cork sealing a wine bottle by hand. The user places helix 102, and fulcrum 112 in an open position as shown in FIG. 1 and holds corkscrew key 100 by lever arm 108. The user then situates helix 102 in a position substantially perpendicular to lever arm 108. Next, the user places the pointed end 104 of helix 102 at a substantially central location of the exposed cylindrical end of the cork. At this juncture, maintaining a substantially perpendicular relationship between helix 102 and the exposed end of the cork is important for successful removal of the cork and for maintaining the cork in a condition that allows for re-entry into the wine bottle.

While pointed end 104 maintains contact with the exposed end of the cork, the user applies a counterclockwise twisting motion to the helix 102 by rotating lever arm 108 with the hand. At the same time, the user must exert downward force to ensure entry of helix 102 into the exposed end of the cork. This simultaneous turning and downward motion, when performed properly, inserts the helix deep within the center of the cork along the cork's vertical axis.

To remove helix 102 from the cork, fulcrum 112 is rotated to allow the distal end of fulcrum 112 to be placed on the out rim of the bottle's opening. The user then rotates lever arm 108 in an upward direction to pry or force helix 102 and the engaged cork from the bottle. Once the cork is removed from the bottle, it is removed from helix 102 by counterclockwise rotation and may be saved or discarded.

Several models of corkscrews are commercially available. A number of attempts have been made to make a corkscrew that increases the likelihood of successful insertion of the helix into the bottle without damaging the cork. Cork breakage during the removal process can ruin the wine drinking experience. Those opening their own wine bottles with typical corkscrew devices such as the one depicted in FIG. 1 want to avoid inaccurate assertion of the helix in a manner that causes cork breakage. Moreover, waiters or bartenders who open wine bottles for paying customers on a regular basis must avoid cork breakage to avoid having irate customers. Waiters required to open a wine bottle tableside for a restaurant patron face the difficult task of accurately engaging the corkscrew helix with the cork for successful cork removal. The waiter's task is made all the more difficult because the waiter opening the bottle tableside does not have the advantage of placing the bottle on the table or other stable surface while engaging the helix into the cork. Instead, the waiter must hold the bottle in one hand while inserting the helix into the cork through the simultaneous twisting and downward force motion process described above. During the twisting or rotating process, the waiter must release the lever arm 108 after an approximately 180 degree turn, and then grasp lever arm 108 again to continue the twisting motion.

Performing the bottle opening process tableside without the benefit of a table or stable surface on which to place the bottle exposes the waiter to the risk of dropping the bottle or damaging the cork during the removal process causing fragments of cork to contaminate the wine. Also, while most waiters do their best to elegantly insert and remove the helix, the process is often far from elegant. What is needed is a corkscrew device that allows easy and accurate insertion of the helix into the cork while permitting the user to maintain both hands on the bottle.

### SUMMARY OF THE INVENTION

The present embodiments disclosed herein are directed to an improved corkscrew apparatus. In one aspect, a corkscrew key includes a ratchet member associated with a central portion of a lever arm, a helix having a shaft associated with the ratchet member, a pointed end of the helix, a fulcrum rotatably attached at a first end of the lever arm and a blade rotatably attached at a second end of the lever arm.

In one aspect, the ratchet housing, helix and shaft members may be formed as a single body member of a material such as metal. In another aspect, the ratchet housing may be integrated into the lever arm of the corkscrew key. In another aspect, the ratchet member may be integrated into a rack and pinion cork removal device.

### BRIEF DESCRIPTION OF THE DRAWINGS

For a more complete understanding of the features and advantages of the present disclosure, reference is now made to the detailed description of the exemplary embodiments, invention along with the accompanying figures in which corresponding numerals in the different figures refer to corresponding parts and in which:

FIG. 1 is a perspective view of a prior art corkscrew key;

FIG. 2 is a perspective view of an embodiment of the present cork removal apparatus.

FIG. 3A is a perspective view of an embodiment of a ratchet device of the present cork removal apparatus.

FIG. 3B is a perspective view of an embodiment of a ratchet device of the present cork removal apparatus.

FIG. 4 is a perspective view of a prior art rack and pinion type cork removal apparatus.

FIG. 5 is a perspective view of an embodiment of the present cork removal apparatus incorporating a rack and pinion type system.

FIG. 6 is a perspective view of an embodiment of the present cork removal apparatus.

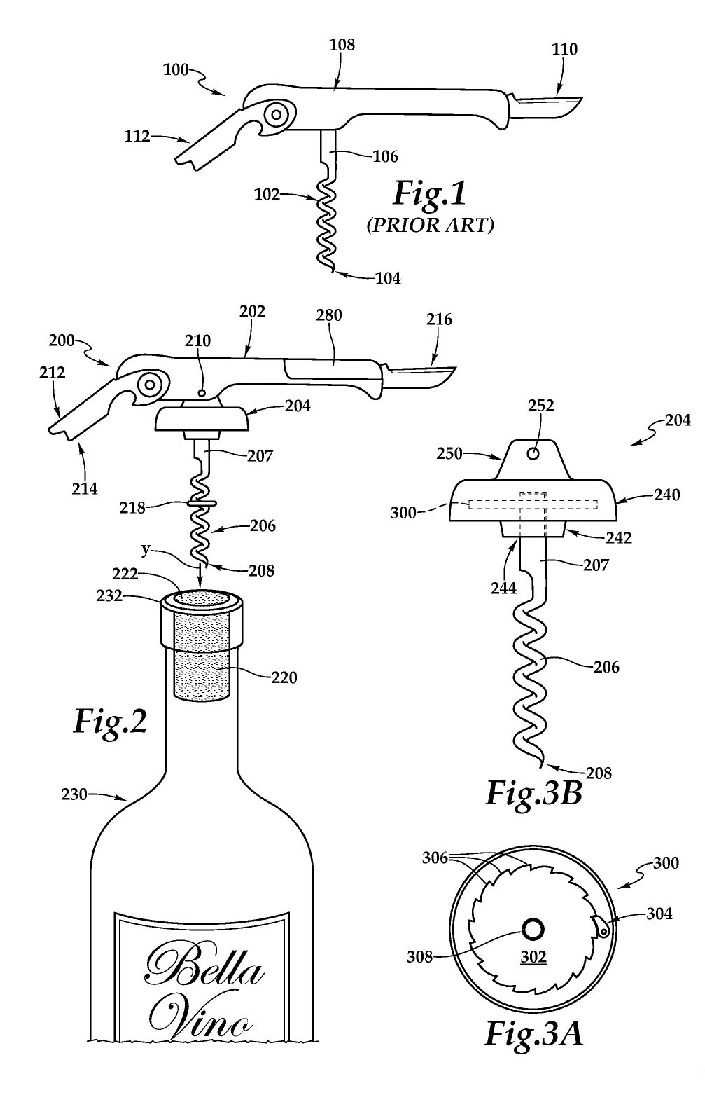

### DETAILED DESCRIPTION OF THE EMBODIMENTS

While the making and using of various embodiments of the present cork removal apparatus are discussed in detail below, it should be appreciated that the present cork removal devices provide many applicable inventive concepts which can be embodied in a wide variety of specific contexts. The specific embodiments discussed herein are merely illustrative of specific ways to make and use the cork removal devices, and do not delimit its scope.

Referring initially to FIG. 2, therein is depicted a cork removal device embodying principles of the present cork removal device that is representatively illustrated and generally designated 200. As shown, cork removal device 200 includes a lever arm 202 that serves as a main body portion of device 200. At a central portion of lever arm 202 is attached a ratchet assembly 204. Ratchet assembly 204 may be attached to lever arm 202 through a pin 210 that is affixed at both ends to the exterior body frame of lever arm 202. Alternatively, the housing of ratchet assembly 204 and lever arm 202 may be of a uniform construction of a single material such as a polymer or metal. A helix 206 is attached perpendicularly to ratchet assembly 204. In this manner, rotation of helix 206 is achieved through use of ratchet assembly 204. Helix 206 may be a wire helix formed of polymer or metal. At a distal end of helix 206 is a pointed end 208. Helix 206 includes a shank section 207 at an end opposite of pointed end 208.

Within ratchet assembly 204 is a ratchet member 300 depicted in FIG. 3A. In FIG. 3A, ratchet member 300 includes gear member 302 and pawl member 304. Gear member 302 includes a plurality of teeth 306 and an axle 308 at a central point of gear member 302. Gear member 302 rotates about axle 308. In one embodiment, pawl member 304 is pivotably attached to the frame of ratchet assembly 204 and in association with gear member 302. Pawl member 304 is shaped to engage within spaces between two teeth 306 of gear member 302. When operating ratchet member 300 as intended, gear member 302 may rotate in only one direction. Assuming gear member 302 is set to rotate in a counterclockwise direction, pawl member 304 locks into place between two adjacent teeth 306 to prevent clockwise rotation of gear member 302. In this manner, ratchet member 300 rotates an associated device in a clockwise direction. Repeated rotation of the device associated with ratchet member 300 is achieved by rotating gear member 302 in the counterclockwise direction (through an associated handle), which in turn causes pawl member 304 to disengage from teeth 306 by rotation about pivot point 308. In this manner, ratchet member 300 produces repeated rotation of a device associated with ratchet member 300 without repeated removal of the operator's hand from the connected device's handle or placement and replacement of device on the object of interest.

A detailed depiction of an embodiment of ratchet assembly 204 is provided in FIG. 3B. Ratchet assembly 204 includes a housing member 240. Housing member 240 is substantially circular in shape and of a size and thickness to house ratchet member 300. Associated with a bottom side of ratchet assembly 204 is helix interface member 242. Helix interface member 242 includes aperture 244 located at a substantially central point of the bottom side of ratchet assembly 204. In one embodiment, aperture 244 is of a size sufficient to receive shank 207 of helix 206. Aperture 244 is also of a depth to permit shank 207 of helix 206 to engage with ratchet member 300. Specifically, shank 207 of helix 206 engages with gear 302 of ratchet member 300 through aperture 244 of helix interface member 242. Helix 206 may be permanently or removably inserted into aperture 244.

Rotation of helix 206 during use of device 200 is achieved through rotation of gear 302. Rotation of gear 302 is achieved by rotating lever arm 202. Rotation of lever arm 202 causes rotation of gear 302 by virtue of lever arm interface member 250 of ratchet assembly 204. Lever arm interface member 250 is associated with the top side of housing 240. Lever arm interface member 250 is of a thickness sufficient to associate with a bottom portion of lever arm 202. In one embodiment, lever arm 202 includes pin 210. Lever arm interface 250 includes opening 252 for receiving pin 210 once lever arm interface 250 is engaged with lever arm 202. In the alternative, lever arm interface member of ratchet assembly 204 may be permanently affixed to lever arm 202 by welding, adhesive or other suitable manner.

In operation, helix 206 is inserted into cork 220 of bottle 230 as follows. The pointed end 208 of helix 206 is directed to a substantially central point of exposed end 222 of cork 220. While maintaining a substantially perpendicular relationship between helix 208 and lever arm 202, a force in a direction y is exerted on lever arm 202 and in turn on helix 206. In order to engage the pointed end 208 of helix 206, lever arm 202 is placed in the user's hand and rotated in a clockwise direction. At the same time, bottle 230 is held to prevent significant movement or rotation. The clockwise turning of lever arm 202 coupled with the force exerted in the y-direction causes pointed end 208 of helix 206 to enter cork 220 at a central point of exposed end 222.

At the completion of a single clockwise turn of lever arm 202, pointed end 208 of helix 206 may only have minimally entered cork 220. A single turn of lever arm 202 typically spans between 90 and 180 degrees. After this single turn of lever arm 202, additional turns of lever arm 202 are typically required to engage helix 206 into cork 220 at a depth sufficient to allow removal of cork 220 from bottle 230. At this juncture, without removing the hand from lever arm 202, the user may rotate lever arm 202 in a clockwise direction back to the original point of rotation. The single direction (counterclockwise) rotation of gear member 302 within ratchet member 300 allows for a resetting of lever arm 202 to a position where additional clockwise turns of lever arm 202 may be made without the user removing the hand from the lever arm. Thus, deeper penetration of helix 206 into cork 220 results without the awkward process of shifting hand positions associated with prior art corkscrew keys.

After the process described above is repeated a number of times, helix 206 penetrates cork 220 to a depth making removal of cork 220 from bottle 230 possible. Removal is achieved by extending fulcrum 212 away from lever arm 202 and positioning the end 214 of fulcrum 212 on the rim 232 of bottle 230. Next, downward pressure is exerted on the distal end of lever arm 202 to pry cork 220 from bottle 230. Once removed, the cork 220 may be removed from helix 206 and saved or discarded. The ratchet member 208 allows for smooth entry and removal of cork 220 from bottle 230 in an efficient and elegant manner.

At an end of lever arm 202 opposite from the end on which fulcrum 212 is pivotably attached is blade 216. Blade 216 serves to cut the foil placed on bottle 230 by the bottler to protect the top of bottle 230 and cork 220. Blade 216 may be folded into the body of lever arm 202 when not in use to provide user safety.

In another embodiment of the present cork removal device, ratchet assembly 204 includes a switch that permits reversal of the rotation of gear 302. In other words, in one state, the switch permits only counterclockwise movement of gear 302 by rotating lever arm 202. In the other state, the switch permits only clockwise movement of gear 302. The advantage of the switch is to take advantage of the ratchet assembly to both insert helix 206 into cork 220 and remove helix 206 from cork 220.

In another aspect of the present cork removal apparatus, ratchet assembly 204 and lever arm 202 may be of a single construction. In the alternative, ratchet assembly 204 may be permanently attached to lever arm 202 with a pin 210 as discussed above or removably attached to lever arm 202 through use of a clip or other suitable fastener.

In another aspect of the present cork removal apparatus, a stop mechanism is inserted between the pointed end 208 of helix 206 and ratchet assembly 204. Stop mechanism 218 may take the form a bar 218 that extends in a substantially perpendicular direction from the vertical axis of helix 206. Upon rotation of lever arm 202 in the appropriate direction, ratchet assembly 204 causes helix 206 to enter cork 220 at exposed end 222. Rotation and return of lever arm 202 and in turn ratchet assembly 204 causes helix 206 to continue to penetrate cork 220. It is desired that helix 206 enter cork 220 at an appropriate depth where fulcrum 212 may be placed at rim 232 of bottle 230 at such a position where leverage exerted on lever arm 202 effectively causes removal of cork 220 from bottle 230. If helix 206 is over-inserted or under-inserted into cork 220, then fulcrum 212 may not be positioned in a manner that permits easy removal of cork 220 by applying vertical force to lever arm 202. To avoid this occurrence, bar 218 is positioned at a substantially central position along the vertical axis of helix 206 to inform the user that an ideal penetration depth of helix 206 has been achieved.

In use, as ratchet assembly 204 is repeatedly turned and returned, helix 206 and associated bar 218 moves in a downward direction into cork 220 along the vertical axis of helix 206. Once bar 218 comes into contact with rim 232 of bottle 230, the contact causes resistance that informs the user that the ideal depth of helix 206 has been achieved. At this point, the user stops turning lever arm 202 and removal of cork 220 may be performed through positioning fulcrum 212 and exerting downward force on lever arm 202.

In another embodiment, stop mechanism may take the form of a circular or semi-circular disk about the vertical axis of helix 208. The circular or semi-circular disk, like bar 218, will come into contact with rim 232 of bottle 230, informing the user that proper helix depth has been achieved. In yet another embodiment, stop mechanism may simply take the form of contrasting the color of an upper portion and a lower portion of helix 206. In this manner, the user may observe the entry into cork 220 of helix 206 and halt turning of lever arm 202 and associated ratchet assembly 204 when the entire lower portion of helix 206 disappears into cork 220. The contrasting colors of helix 206 allow the user to easily see the when the ideal point of entry has been achieved.

In another embodiment, lever arm 202 may include an extendable body member 280. Extendable body member 280 may be maintained in a closed position during the process of inserting helix 206 into cork 220. Once helix 206 has been inserted into cork 220 at the necessary depth for effective removal, extendable body member 280 may be drawn from within lever arm 202 in a telescoping fashion. Alternatively, extendable body member 280 may be rotatably attached to an end of lever arm 202, through use of a hinge or rivet. Extending extendable body member 280 effectively increases the length of lever arm 202. When fulcrum 212 is positioned properly, this lengthening of lever arm 202 makes removal of cork 220 through the exertion of upward force on lever arm 202 less difficult.

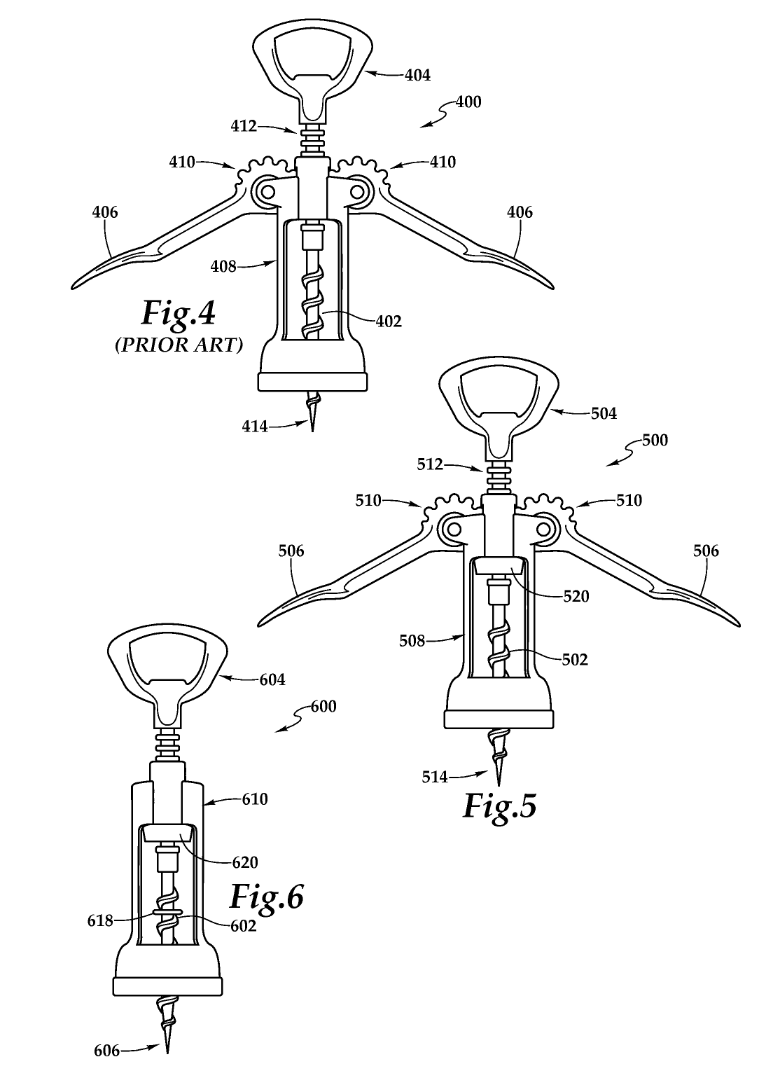

In another aspect of the present cork removal system, ratchet assembly 208 and a ratchet member 300 are integrated into the frame of a rack and pinion type corkscrew. A typical rack and pinion type corkscrew is depicted in FIG. 4. In FIG. 4, corkscrew 400 includes helix 402 having a pointed end 414 for insertion into a cork 220 of a bottle 230. Helix 402 is inserted into cork 220 by applying pointed end 414 at a substantially central point of an exposed end 222 of cork 220. Helix 402 penetrates cork 220 by applying pressure in a downward direction while turning handle 406 of corkscrew 400 in a clockwise direction. In a traditional rack and pinion corkscrew, wings 406 are rotataby attached to frame 408. At the proximate end of each wing 406 is a pinion member 410. A rack member 412 extends below handle 404. When handle 404 is rotated in a clockwise direction to cause helix 402 to enter cork 220, each individual rack of rack member 412 interacts with pinion member 410, causing wings 406 to move in a upward direction away from frame 408. When full penetration of helix 402 is achieved, wings 406 will be in a substantially vertical position. At this point, downward pressure may be exerted on each wing, causing cork 220 to be pried from bottle 230.

In one aspect of the cork removal apparatus, a ratchet assembly similar to the assembly discussed with regard to FIGS. 2 and 3A and 3B may be integrated into corkscrew 400 to supplement or supplant the rack and pinion style cork removal system. Referring to FIG. 5, a corkscrew 500 having a ratchet assembly, including components depicted in FIGS. 3A and 3B, are shown. In this embodiment, ratchet assembly 520, including the ratchet member 300 having gear 302 and pawl 304 is inserted between handle 504 and helix 502. The ratchet assembly 520 may be integrated into the corkscrew 500 as a single-bodied member or may be detachably installed between handle 504 and helix 502 using fasteners known in the art. Once installed, ratchet assembly 520 operates in a similar manner as described in connected with FIG. 2 and may be further equipped with a switch to allow use of the ratchet assembly 520 to both insert helix 502 into cork 220 and remove cork 220 from helix 502. In the system of FIG. 5, wings 506, movably attached to a cylindrical body member 508, pinions 510 and rack 512 function to raise wings 506 to facilitate removal of cork 220 from bottle 230 once helix 502 is fully inserted into cork 220.

Referring to FIG. 6, a corkscrew 600 is depicted that is similar to the corkscrew of FIG. 5, except wings are not employed. In this embodiment, rack and pinion members are not employed. However, similar to FIG. 5, ratchet assembly 620, including ratchet member 300 of FIG. 3 having a gear 302 and pawl 304 is inserted within the circumference of a cylindrical body frame 610 and between a handle 604 and helix 602. In this embodiment, handle 604 is rotated in a clockwise direction while asserting downward pressure onto the cork 220 while maintaining helix 602 in a substantially vertical position. Once handle 604 is rotated, for example, 180 degrees in a clockwise direction, ratchet assembly 620 allows handle 604 to be rotated in a counterclockwise manner back to its original position without removing helix 602 from cork 220. Similar to the operation of the previously described corkscrews, ratchet assembly 620 permits maximum penetration of helix 602 into cork 220 without the need for the user to switch hands or apply and reapply the user's hands to the corkscrew handle. In addition, the ratchet member 300 of ratchet assembly 620 could include a switch to allow two directional use. In one state, handle 604 may be turned in a clockwise direction to permit entry of helix 602 into cork 220 and then handle 604 may be turned in a counterclockwise direction to return handle 604 to its original state.

In another aspect of the present cork removal apparatus, a stop member 618 is inserted between pointed end 606 of helix 602 and ratchet assembly 620. Stop mechanism 618 may take the form a bar that extends in a substantially perpendicular direction from the vertical axis of helix 602. Upon rotation of handle 604 in the appropriate direction, ratchet assembly 620 causes helix 602 to enter cork 220 at exposed end 222. Rotation and return of handle 604 and in turn ratchet assembly 620 causes helix 602 to continue to penetrate cork 220. It is desired that helix 602 enters cork 220 at an appropriate depth where upward force exerted on handle 604 causes cork 220 to be removed from bottle 230. If helix 602 is over-inserted into cork 220, then cork 220 may split, introducing debris to the contents of bottle 230. If helix 602 is under-inserted, upward force on handle 604 may cause helix 602 to be removed from cork 220, but not removal of cork 220 from bottle 230. After such an occurrence, re-insertion of helix 602 into cork 220 may be difficult. To avoid these occurrences, stop member 618 is positioned at a substantially central position along the vertical axis of helix 602 between a pointed end 606 of helix 602 and ratchet assembly 620 to inform the user that an ideal penetration depth of helix 602 has been achieved.

In use, as ratchet assembly 620 is repeatedly turned and returned through handle 604, helix 602 and stop member 618 move in a downward direction into cork 220 along the vertical axis of helix 602. Once stop member 618 comes into contact with rim 232 of bottle 230, the contact causes resistance that informs the user that the ideal depth of helix 602 has been achieved. At this point, the user stops turning handle 604 and removal of cork 220 may be performed by exerting upward force or pulling handle 604.

In another embodiment, stop mechanism may take the form of a circular or semi-circular disk about the vertical axis of helix 602. The circular or semi-circular disk, like a bar, will come into contact with rim 232 of bottle 230, informing the user that proper helix depth has been achieved. In yet another embodiment, stop mechanism 618 may simply take the form of contrasting the surface appearance of an upper portion and a lower portion of helix 602. This may be achieved by coating helix 602 with different colors or manufacturing the upper and lower portions of helix 602 from different materials, such as metal or plastic. In this manner, the user may observe the entry into cork 220 of helix 602 and halt turning of handle 604 and associated ratchet assembly 620 when the entire lower portion of helix 602 disappears into cork 220. The contrasting appearance of helix 602 allow the user to easily see the when the ideal point of entry has been achieved.

While the aspects of the present cork removal apparatus previously discussed contemplate manual operation, the features disclosed herein may be easily incorporated into a motorized or battery operator cork removal apparatus.

While the present cork removal apparatus has been described with reference to illustrative embodiments, this description is not intended to be construed in a limiting sense. Various modifications and combinations of the illustrative embodiments as well as other embodiments of the in, will be apparent to persons skilled in the art upon reference to the description. It is, therefore, intended that the appended claims encompass any such modifications or embodiments.

What is claimed is:

1. A cork removal apparatus, comprising:
a central body portion having a first end and a second end;
a helix having a pointed end and a shank end associated with the central body portion;
a fulcrum pivotably attached to the first end of the central body portion; and
a ratchet assembly associated with the helix.

2. The cork removal apparatus of claim 1, further comprising:
a ratchet assembly housing;
a gear member and a pawl member contained within the ratchet assembly housing;
a helix interface unit including an aperture for receipt of the shank end of the helix.

3. The cork removal apparatus of claim 2, further comprising an extension member movably attached to the central body portion.

4. The cork removal apparatus of claim 3, wherein the extension member is pivotably attached to an end of the central body portion.

5. The cork removal apparatus of claim 4, further comprising a blade connected to the second end of the central body portion.

6. The cork removal apparatus of claim 2, wherein the gear member and pawl member permit rotation of the helix in one direction.

7. The cork removal apparatus of claim 2, further comprising a switch associated with the ratchet assembly, wherein a first state of the switch permits rotation of the helix in one direction and a second state of the switch permits rotation of the helix in a second direction.

8. The cork removal apparatus of claim 1, further comprising:
a stop indication member situated below the ratchet assembly and above a pointed end of the helix.

9. The cork removal apparatus of claim 8, wherein the stop indication member extends in a substantially perpendicular direction from the vertical axis of the helix.

10. The cork removal apparatus of claim 8, wherein the stop indication member comprises a first material having a first visual characteristic applied to an upper portion of the helix and a second material having a first visual characteristic applied to a lower portion of the helix.

11. A cork removal apparatus, comprising:
a rotatable handle;
a ratchet assembly associated with the rotatable handle; and
a helix having a pointed and a shank end attached to the ratchet assembly,
wherein the longitudinal axis of the rotating handle is substantially perpendicular to the longitudinal axis of the helix.

12. The cork removal apparatus of claim 11, further comprising:
a ratchet assembly housing;
a gear member and a pawl member contained within the ratchet assembly housing;
a helix interface unit including an aperture for receipt of the shank end of the helix.

13. The cork removal apparatus of claim 12, further comprising a cylindrical central body portion, wherein the ratchet assembly resides within the cylindrical central body portion.

14. The cork removal apparatus of claim 12, wherein the gear member and pawl member permit rotation of the helix in one direction.

15. The cork removal apparatus of claim 14, further comprising a switch associated with the ratchet assembly, wherein a first state of the switch permits rotation of the helix in one direction and a second state of the switch permits rotation of the helix in a second direction.

16. The cork removal apparatus of claim 12, further comprising:
a stop indication member situated below the ratchet assembly and above a pointed end of the helix.

17. The cork removal apparatus of claim 16, wherein the stop indication member extends in a substantially perpendicular direction from the vertical axis of the helix.

18. The cork removal apparatus of claim 17, wherein the stop indication member comprises a first material having a first visual characteristic applied to an upper portion of the helix and a second material having a first visual characteristic applied to a lower portion of the helix.

19. A cork removal system, comprising:
a ratchet assembly having a gear member and a pawl member;
a housing substantially enclosing the gear member and pawl member;
a helix interface member associated with a first side of the housing;
an aperture within the helix interface member at a substantially central point relative to the first side of the housing, and
a helix having a pointed end and a shank end,
wherein the aperture is sized to receive the shank end of the helix.
